(19) United States
(12) Patent Application Publication
(10) Pub. No.: US 2026/0243342 A1
(43) Pub. Date: Aug. 20, 2026

(54) GUARDS FOR SUNSHELLS IN TRANSMISSIONS, AND SYSTEMS, KITS, AND TRANSMISSIONS COMPRISING GUARDS

(71) Applicant: Thomas Rodriguez, Tulare, CA (US)

(72) Inventor: Thomas Rodriguez, Tulare, CA (US)

(21) Appl. No.: 19/058,436

(22) Filed: Feb. 20, 2025

(51) Int. Cl. F16H 57/08; F16H 57/00

(52) U.S. Cl. CPC F16H 57/08; F16H 2057/0068

(57) ABSTRACT

Guards for sunshells in transmissions, and systems, kits, and transmissions comprising guards are provided. The guard comprises an annular body comprising a first guard end, a second guard end, and a guard elongate portion extending from the first guard end to the second guard end. The guard elongate portion defines a longitudinal axis of the annular body. The guard elongate portion comprises an inner surface defining a first cavity extending from the first guard end to the second guard end. The guard is capable to be positioned intermediate an end of the sunshell and a low and reverse race to inhibit wear on the end of the sunshell.

### BACKGROUND

Transmission have various moving components. Manufacturing a transmission that operates for long periods of time presents challenges.

### SUMMARY

According to non-limiting aspects of the present disclosure, a guard for a sunshell in a transmission is provided. The guard comprises an annular body comprising a first guard end, a second guard end, and a guard elongate portion extending from the first guard end to the second guard end. The guard elongate portion defines a longitudinal axis of the annular body. The guard elongate portion comprises an inner surface defining a first cavity extending from the first guard end to the second guard end. The guard is capable to be positioned intermediate an end of the sunshell and a low and reverse race to inhibit wear on the end of the sunshell.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1A is a side view of an example of a guard according to the present disclosure;

FIG. 1B is a top view of the guard of FIG. 1A;

FIG. 1C is a cross-sectional view of the guard of FIG. 1B taken across line 1C-1C;

FIG. 2 is an example of a transmission according to the present disclosure comprising the guard of FIG. 1A; and

FIG. 3 is side view of an example of an arrow shaped clasp according to the present disclosure.

Corresponding reference characters indicate corresponding parts throughout the several views. The exemplifications set out herein illustrate certain non-limiting embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed guards, systems, kits, and transmissions. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

As used herein, “intermediate” means that the referenced element is between two elements but is not necessarily in contact with either of those elements. Accordingly, unless stated otherwise herein, an element that is “intermediate” a first element and a second element may or may not be adjacent to or in contact with the first element and/or the second element, and other elements may be between the intermediate element and the first element and/or the second element.

In certain transmissions, such as, for example, the 4L60-E automatic transmission, many parts can wear over time that may need replaced. The 4L60-E is shown and described in the Hydra-Matic 4L60-E Technician's Guide by GM Motors Corporation, 1992, and the Catalog for parts in TH700-R4 (MD8), 4L60, 4L60E(M30), 4L65E(M32), 4L70E (M70) by Transtar Industries, Inc. 2008, both of which are incorporated by reference herein. The present inventor determined that interactions between the sunshell and the low and reverse race can lead to undesirable wear on the transmission. Thus, the present disclosure provides a guard for a sunshell in a transmission, systems comprising the guard, kits comprising the guard, and transmissions comprising the guard. The present disclosure can reduce undesirable wear on the sunshell, which can enhance operation of the transmission.

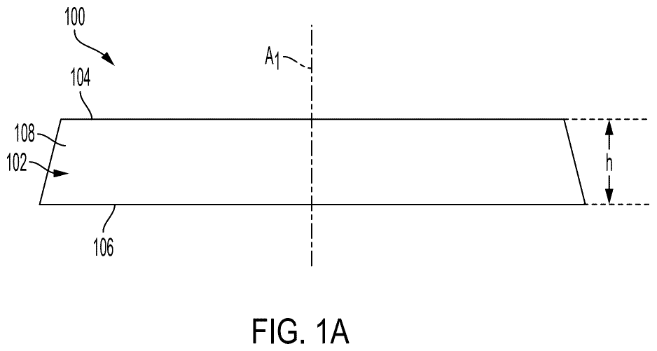

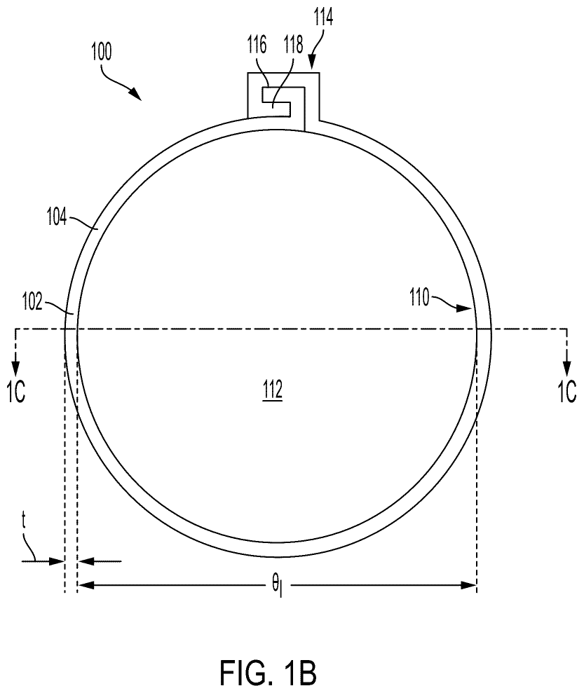

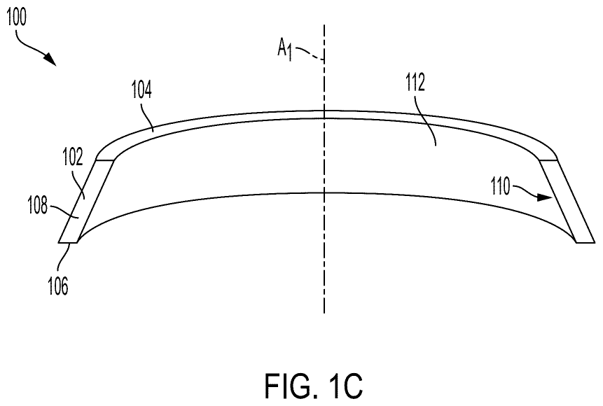

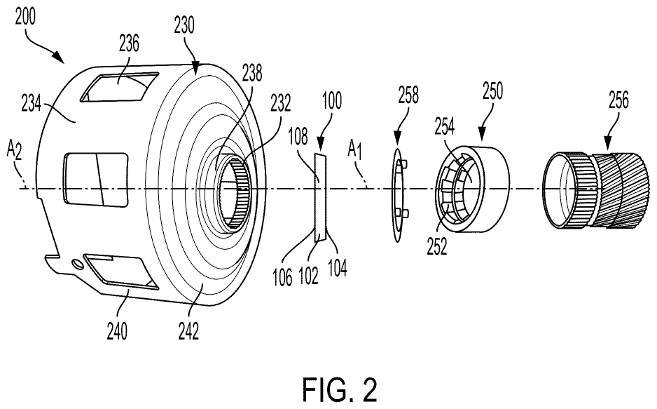

Referring to FIG. 1A, the guard 100 comprises an annular body 102 comprising a first guard end 104, a second guard end 106, and a guard elongate portion 108 extending from the first guard end 104 to the second guard end 106. The guard 100 can be configured to engage a sunshell (e.g., sunshell 230 in FIG. 2). For example, the guard 100 can be positioned intermediate an end of the sunshell and a low and reverse race to inhibit wear on the end of the sunshell.

The guard elongate portion 108 can define a longitudinal axis, A₁, of the annular body 102. The guard elongate portion 108 can comprise an inner surface 110 defining a first cavity 112 extending from the first guard end 104 to the second guard end 106.

The annular body can comprise an inner diameter, θ_{I}, suitable to receive an end of a sunshell. For example, the inner diameter, θ_{I}, in a range of 55 mm to 65 mm, such as, for example, in a range of 55 mm to 60 mm, 58 mm to 65 mm, 56 mm to 64 mm, 57 mm to 63 mm, 57 mm to 62 mm, or 58 mm to 60 mm. The inner diameter, θ_{I}, can be measured at the first end 104.

The inner diameter, θ_{I}, of the first cavity 112 can decrease from the second guard end 106 to the first guard end 104. For example, the first cavity 112 can narrow from the second guard end 106 to the first guard end 104.

The shape of the guard 100 can be configured to be retained by an end of a sunshell and be retained within a cavity of a low and reverse race. In various examples, the guard 100 can comprise a frustoconical shape.

The annular body 102 can comprise a radial thickness, t, suitable to facilitate positioning of the guard 100 intermediate an end of the sunshell and a low and reverse race while retaining a sufficient thickness to inhibit wear on the end of the sunshell. For example, radial thickness, t, can be in a range of 1 mm to 4 mm, such as, for example, 1.5 mm to 3.5 mm, 1.5 mm to 3 mm, or 2 mm to 2.5 mm. In various examples, the thickness, t, can be less than a thickness of a gap present between a low and reverse race and a first annular portion of a sunshell.

The annular body 102 can comprise a height, h, extending along the longitudinal axis, A₁, in a range of 0.1 mm to 0.5 mm, such as, for example, 0.15 mm to 0.3 mm.

The guard 100 can comprise various materials as needed for the application. For example, the guard 100 can comprise a metal or metal alloy that exhibits a hardness less than a hardness of a sun gear. For example, the guard 100 can comprise brass. In various examples, the guard 100 can be self-lubricating.

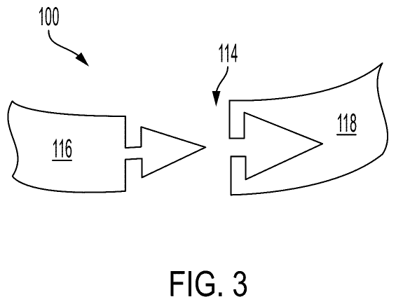

In various examples, the guard 100 can comprise a clasp 114 connecting a third end 116 of the guard elongate portion 108 to a fourth end 118 of the guard elongate portion 108. In certain examples, the clasp 114 can be u-shaped as illustrated in FIG. 1B or arrow shaped as in FIG. 3. The clasp 114 can facilitate manufacturing of the guard 100. For example, the guard 100 can be formed from a strip that is connected together to form the guard 100.

The guard 100 can be included in a kit for repairing a transmission. The kit can comprise only the guard 100, or the guard 100 and additional components, such as, for example, seals, gaskets, bushings, gears, and/or other components.

Referring to the exploded view of a transmission 200 in FIG. 2, the guard 100 can be positioned intermediate a first sunshell end 232 of the sunshell 230 and a low and reverse race 250 to inhibit wear on the end 232 of the sunshell 230. In various non-limiting embodiments, the guard 100 can be integral with the sunshell 230 or the guard 100 may be separate from the sunshell 230.

The sunshell 230 can comprise the first sunshell shell end 232, a second sunshell end 234, and a sunshell elongate portion 236 extending from the first sunshell end 232 to the second sunshell end 234. The sunshell elongate portion 236 can define a longitudinal axis, A₂, of the sunshel. The longitudinal axis, A₂, can be substantially aligned with the longitudinal axis, Aₗ.

The sunshell elongate portion 236 can comprises a first annular portion 238, a second annular portion 240, and a third annular portion 242. The first annular portion 238 can extend along the second longitudinal axis, A₂, a first distance, d₁, from the first sunshell end 232. The second annular portion 240 can extend along the second longitudinal axis a second distance, d₂, from the second sunshell end 234. The third annular portion 242 can extend from the first annular portion 238 outwardly relative to the longitudinal axis, A₂, to the second annular portion 240.

The first annular portion 238 can be disposed at least partially within the cavity 112 of the annular body 102 of the guard 100. The second guard end 106 can be positioned against the third annular portion 242. The first guard end 104 can be positioned adjacent to the first sunshell end 232. In various examples, the guard 100 can be attached to the first annular portion 238 such that the guard 100 is capable to rotate by rotation of the sunshell 230.

The low and reverse race 250 can comprise an inner surface 252 defining a cavity 254. For example, the low and reverse race 250 can be tubular. The guard 100 can be at least partially positioned within the cavity 254. The guard 100 can inhibit the low and reverse race 250 from damaging the third annular portion 242 and/or first annular portion 238 of the sunshell 230.

The transmission 200 can optionally comprise a sun gear 256 suitable to be received by the cavity 254 of the low and reverse race 250 and engage the first sunshell end 232. The transmission can optionally comprise a bushing 258 that does not substantially enter the cavity 254 and engages the face of the low and reverse race 250 and/or the third annular portion 242. The bushing 258 can comprise an internal diameter larger than the guard 100.

Various aspects of embodiments according to the present disclosure include, but are not limited to, the aspects listed in the following numbered clauses.

Clause 1. A guard for a sunshell in a transmission, the guard comprising: an annular body comprising: a first guard end, a second guard end, and a guard elongate portion extending from the first guard end to the second guard end, the guard elongate portion defining a longitudinal axis of the annular body, the guard elongate portion comprising an inner surface defining a first cavity extending from the first guard end to the second guard end, wherein the guard is capable to be positioned intermediate an end of the sunshell and a low and reverse race to inhibit wear on the end of the sunshell.

Clause 2. The guard of clause 1, wherein the annular body comprises: an inner diameter in a range of 55 mm to 65 mm, a radial thickness in a range of 1 mm to 4 mm, and a height extending along the first longitudinal axis in a range of 0.1 mm to 0.5 mm.

Clause 3. The guard of any of clauses 1-2, wherein the annular body comprises an inner diameter in a range of 58 mm to 60 mm.

Clause 4. The guard of any of clauses 1-3, wherein the annular body extends along the first longitudinal axis a distance in a range of 0.15 mm to 0.3 mm.

Clause 5. The guard of any of clauses 1-4, wherein the annular body comprises a radial thickness in a range of 2 mm to 2.5 mm.

Clause 6. The guard of any of clauses 1-5, wherein the guard is self-lubricating.

Clause 7. The guard of any of clauses 1-6, wherein the guard comprises a metal alloy that exhibits a hardness less than a hardness of the low and reverse race.

Clause 8. The guard of any of clauses 1-7, wherein the guard comprises brass.

Clause 9. The guard of any of clauses 1-8, wherein the guard further comprises a clasp connecting a third end of the guard elongate portion to a fourth end of the guard elongate portion.

Clause 10. The guard of claim of clause 9, wherein the clasp is u-shaped or arrow shaped.

Clause 11. The guard of any of clauses 1-10, wherein a diameter of the first cavity decreases from the second guard end to the first guard end.

Clause 12. A system for use in a transmission comprising: a sunshell comprising a first sunshell shell end, a second sunshell end, a sunshell elongate portion extending from the first sunshell end to the second sunshell end, the sunshell elongate portion defining a second longitudinal axis of the sunshell, the sunshell elongate portion comprising a first annular portion extending along the second longitudinal axis a first distance from the first sunshell end, a second annular portion extending along the second longitudinal axis a second distance from the second sunshell end, and a third portion extending from the first annular portion outwardly relative to the second longitudinal axis to the second annular portion, and the guard of any of clauses 1-11, wherein the first annular portion is disposed at least partially within the first cavity of the annular body of the guard.

Clause 13. The system of clause 12, further comprising a low and reverse race comprising an inner race surface defining a second cavity therein, wherein the guard is at least partially positioned within the second cavity.

Clause 14. The system of any of clauses 12-13, wherein the guard is attached to the first annular portion such that the guard is capable to rotate by rotation of the sunshell.

Clause 15. A transmission comprising the guard of any of clauses 1-11.

Clause 16. A transmission comprising the system of clause 12.

Clause 17. A kit for repairing a transmission, the kit comprising the guard of any of clauses 1-11.

One skilled in the art will recognize that the guards, devices, systems, structures, methods, operations/actions, and objects described herein, and the accompanying discussion, are non-limiting examples presented for the sake of conceptual clarity and that various modifications to the disclosed configurations are contemplated. Consequently, as used herein, the specific examples/embodiments set forth, and the accompanying discussion, are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

Any references herein to “various embodiments”, “some embodiments”, “one embodiment”, “an embodiment”, a “non-limiting embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

What is claimed is:

1. A guard for a sunshell in a transmission, the guard comprising:
an annular body comprising:
a first guard end,
a second guard end, and
a guard elongate portion extending from the first guard end to the second guard end, the guard elongate portion defining a longitudinal axis of the annular body, the guard elongate portion comprising an inner surface defining a first cavity extending from the first guard end to the second guard end,
wherein the guard is capable to be positioned intermediate an end of the sunshell and a low and reverse race to inhibit wear on the end of the sunshell.

2. The guard of claim 1, wherein the annular body comprises:
an inner diameter in a range of 55 mm to 65 mm,
a radial thickness in a range of 1 mm to 4 mm, and
a height extending along the first longitudinal axis in a range of 0.1 mm to 0.5 mm.

3. The guard of claim 1, wherein the annular body comprises an inner diameter in a range of 58 mm to 60 mm.

4. The guard of claim 1, wherein the annular body extends along the first longitudinal axis a distance in a range of 0.15 mm to 0.3 mm.

5. The guard of claim 1, wherein the annular body comprises a radial thickness in a range of 2 mm to 2.5 mm.

6. The guard of claim 1, wherein the guard is self-lubricating.

7. The guard of claim 1, wherein the guard comprises a metal alloy that exhibits a hardness less than a hardness of the low and reverse race.

8. The guard of claim 1, wherein the guard comprises brass.

9. The guard of claim 1, wherein the guard further comprises a clasp connecting a third end of the guard elongate portion to a fourth end of the guard elongate portion.

10. The guard of claim of claim 9, wherein the clasp is u-shaped or arrow shaped.

11. The guard of claim 1, wherein a diameter of the first cavity decreases from the second guard end to the first guard end.

12. A system for use in a transmission comprising:
a sunshell comprising
a first sunshell shell end,
a second sunshell end,
a sunshell elongate portion extending from the first sunshell end to the second sunshell end, the sunshell elongate portion defining a second longitudinal axis of the sunshell, the sunshell elongate portion comprising
a first annular portion extending along the second longitudinal axis a first distance from the first sunshell end,
a second annular portion extending along the second longitudinal axis a second distance from the second sunshell end, and
a third portion extending from the first annular portion outwardly relative to the second longitudinal axis to the second annular portion, and
the guard of claim 1, wherein the first annular portion is disposed at least partially within the first cavity of the annular body of the guard.

13. The system of claim 12, further comprising a low and reverse race comprising an inner race surface defining a second cavity therein, wherein the guard is at least partially positioned within the second cavity.

14. The system of claim 12, wherein the guard is attached to the first annular portion such that the guard is capable to rotate by rotation of the sunshell.

15. A transmission comprising the guard of claim 1.

16. A transmission comprising the system of claim 12.

17. A kit for repairing a transmission, the kit comprising the guard of claim 1.
